(19) United States
(12) Patent Application Publication
(10) Pub. No.: US 2019/0351911 A1
(43) Pub. Date: Nov. 21, 2019

(54) VEHICLE

(71) Applicant: Panasonic Intellectual Property Management Co., Ltd., Osaka (JP)

(72) Inventor: MASAHIRO ANEZAKI, Tokyo (JP)

(21) Appl. No.: 16/530,609

(22) Filed: Aug. 2, 2019

Related U.S. Application Data
(63) Continuation of application No. PCT/JP2018/004534, filed on Feb. 9, 2018.

(30) Foreign Application Priority Data
Mar. 1, 2017 (JP) 2017-038600

(51) Int. Cl. B60W 40/06; B60W 50/14; G05D 1/02

(52) U.S. Cl. CPC B60W 40/06; B60W 50/14; B60W 2550/402; B60W 2550/12; G05D 1/0214

(57) ABSTRACT

This vehicle is capable of autonomously traveling through a path and includes: an input unit configured to receive elevation information of the path; a sensor configured to detect a water surface in a traveling direction; and an output unit. When a water depth at a location in the traveling direction along a predetermined path is estimated to be equal to or greater than a predetermined value on the basis of the elevation information of the predetermined path received by the input unit and the water surface detected by the sensor while the vehicle autonomously travels along the predetermined path, the output unit provides a warning about a possibility of a submergence.

### CROSS REFERENCE TO RELATED APPLICATIONS

This application is a continuation of the PCT International Application No. PCT/JP2018/004534 filed on Feb. 9, 2018, which claims the benefit of foreign priority of Japanese patent application No. 2017-038600 filed on Mar. 1, 2017, the contents all of which are incorporated herein by reference.

### BACKGROUND

### 1. Technical Field

The present disclosure relates to a vehicle such as a vehicle capable of autonomously traveling through a path.

### 2. Description of the Related Art

In recent years, along with downsizing and performance improvement of in-vehicle sensors and computers, an autonomous vehicle which requires no driving operation by a driver has begun to spread. In the case of the autonomous vehicle, a path in which the vehicle is scheduled to travel (scheduled travel path) needs to be set in advance according to the set destination or the like.

On the other hand, regardless of whether or not the vehicle is an autonomous vehicle, if there is a hazard such as a flood (submergence) and a puddle on a road, it is necessary to ensure the safe travel of the vehicle. Particularly, in the case of autonomous driving, there is a need to ensure the safe travel of the vehicle over the entirety of the scheduled travel path.

### SUMMARY

The present disclosure provides a vehicle capable of improving the safety of traveling.

A vehicle according to one aspect of the present disclosure is capable of autonomously traveling through a path and includes: an input unit configured to receive elevation information of the path; a sensor configured to detect a water surface in a traveling direction of the vehicle; and an output unit. When a water depth at a location in a traveling direction along a predetermined path is estimated to be equal to or greater than a predetermined value on the basis of the elevation information of the predetermined path received by the input unit and a water surface in the predetermined path detected by the sensor while the vehicle autonomously travels along the predetermined path, the output unit provides a warning about a possibility of a submergence.

Note that a resultant by conversion of an aspect of the present disclosure between a method, an apparatus, a system, a recording medium (including a computer-readable, non-transitory recording medium), a computer program, and the like is also effective as an aspect of the present disclosure.

According to the present disclosure, it is possible to improve the safety of a vehicle while traveling.

### BRIEF DESCRIPTION OF DRAWINGS

FIG. 1 is a configuration diagram of a hazard handling system according to a first exemplary embodiment.

FIG. 2 is a flowchart illustrating an operational flow of the hazard handling system and an autonomous driving control apparatus according to the first exemplary embodiment.

FIG. 3 is a flowchart illustrating one example of an operational flow in Step S14 in the flowchart illustrated in FIG. 2.

FIG. 4 is a flowchart illustrating one example of an operational flow in Step S21 in the flowchart illustrated in FIG. 3.

FIG. 5 is a diagram for describing the maximum water level in a scheduled travel path.

FIG. 6 is a flowchart illustrating one example of an operational flow in Step S22 in the flowchart illustrated in FIG. 3. FIG. 7 is a flowchart illustrating one example of an operational flow in

Step S21 to Step S25 in the flowchart illustrated in FIG. 3.

FIG. 8 is a configuration diagram of a vehicle according to a second exemplary embodiment.

FIG. 9 is a flowchart illustrating an operational flow of the vehicle according to the second exemplary embodiment.

FIG. 10 is a diagram illustrating one example of a hardware configuration of a computer.

### DETAILED DESCRIPTION OF PREFERRED EMBODIMENTS

Prior to describing exemplary embodiments of the present disclosure, a problem with a conventional technique is described briefly. A traffic information system that allows avoidance of an impassable area of a flood, a puddle, or the like that is created on a road during rain, etc., has been proposed. In the technique disclosed in Japanese Unexamined Patent Publication No. 2004-341795, the presence of a submergence at the current location of a vehicle is checked using a submergence sensor. However, whether or not the vehicle can travel through a scheduled travel path cannot be determined by checking the presence of a submergence in the current location of the vehicle.

Hereinafter, exemplary embodiments of the present disclosure will be described in detail with reference to the drawings.

### First Exemplary Embodiment

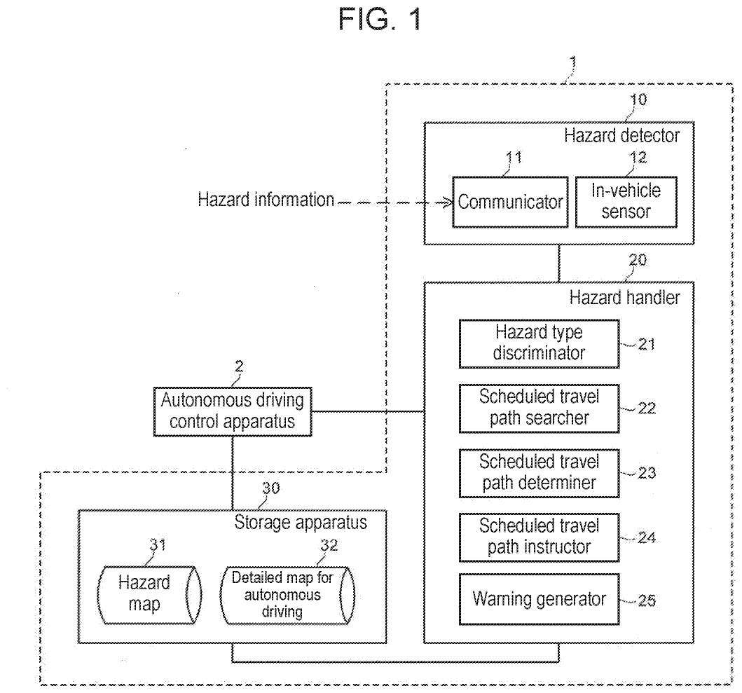

FIG. 1 is a configuration diagram of hazard handling system 1 according to a first exemplary embodiment. Hazard handling system 1 includes hazard detector 10, hazard handler 20, and storage apparatus 30.

Hazard detector 10 detects the occurrence of a hazard. Here, the hazard is a disaster such as a submergence, a landslide, an earthquake, a windstorm, and a snow coverage that may damage a vehicle or hinder the travel of a vehicle. In one example, hazard detector 10 includes a computer which includes a central processing unit (CPU) and a read-only memory (ROM) and in which the CPU reads and executes each program stored in the ROM.

Hazard detector 10 includes communicator 11 and in-vehicle sensor 12.

Communicator 11 acquires information (hazard information) indicating the occurrence of a hazard from the outside via a network. In one example, the network is the Internet, and communicator 11 is an internet terminal. In another example, the network is a dedicated short-range communication (DSRC) path, and communicator 11 is an in-vehicle device that supports the electronic toll collection (ETC) system 2.0 of Japan. In one example, the hazard information includes information indicating the type of the hazard.

Hazard detector 10 detects the occurrence of a hazard in response to acquiring the hazard information by communicator 11.

In-vehicle sensor 12 generates measurement data indicating a physical quantity related to the hazard. Hazard detector 10 detects the occurrence of the hazard on the basis of the measurement data from in-vehicle sensor 12.

In one example, in-vehicle sensor 12 is a fathometer which measures the water depth from the bottom to the top (water surface) of a submergence part in the current location of the vehicle using ultrasonic waves, etc., and generates measurement data indicating the depth. In one example, when the water depth is greater than a first threshold value, hazard detector 10 detects the occurrence of a submergence hazard.

Hazard handler 20 includes hazard type discriminator 21, scheduled travel path searcher 22, scheduled travel path determiner 23, scheduled travel path instructor 24, and warning generator 25. In one example, hazard handler 20 is a computer which includes a CPU and a ROM and in which the CPU reads and executes a program stored in the ROM.

Hazard type discriminator 21 discerns the type of a hazard on the basis of the hazard information acquired by communicator 11. Examples of the type of a hazard include a submergence hazard, a landslide hazard, an earthquake hazard, a windstorm hazard, and a snow coverage hazard.

Scheduled travel path searcher 22 searches for a scheduled travel path candidate from the current location of the vehicle to a destination by using a road map in detailed map 32 for autonomous driving and an algorithm such as Dijkstra's algorithm. In one example, scheduled travel path searcher 22 acquires the current location of the vehicle from autonomous driving control apparatus 2. In one example, scheduled travel path searcher 22 retrieves two or more scheduled travel path candidates from the current location of the vehicle to the destination in ascending order from the shortest path length.

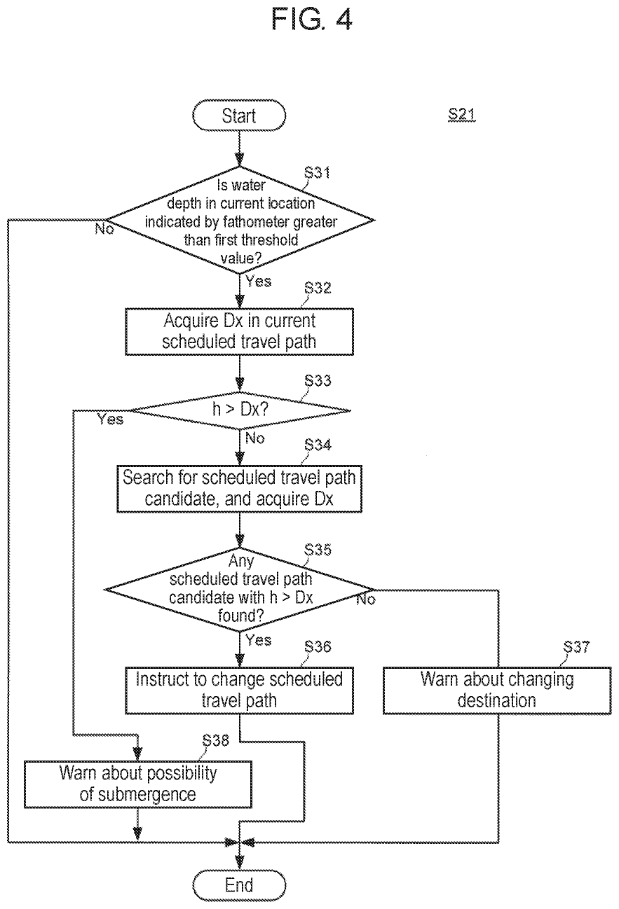

Scheduled travel path determiner 23 determines whether it is safe or unsafe for the vehicle to travel on the scheduled travel path that has been set. Furthermore, upon determining that it is unsafe for the vehicle to travel on the scheduled travel path that has been set, scheduled travel path determiner 23 discerns whether it is safe or unsafe for the vehicle to travel on each of the two or more scheduled travel path candidates retrieved by scheduled travel path searcher 22. Next, scheduled travel path determiner 23 determines a scheduled travel path that is safe for the vehicle to travel. Details of the process of discerning and determining the scheduled travel path by scheduled travel path determiner 23 will be described later with reference to FIG. 4 to FIG. 7.

Scheduled travel path instructor 24 instructs autonomous driving control apparatus 2 about the scheduled travel path determined by scheduled travel path determiner 23. After receiving the instruction, autonomous driving control apparatus 2 sets the scheduled travel path specified in the instruction, and drives the vehicle along the scheduled travel path that has been set.

When there is no scheduled travel path candidate that scheduled travel path determiner 23 determines as being safe for the vehicle to travel, warning generator 25 warns autonomous driving control apparatus 2 that the destination needs to be changed.

Storage apparatus 30 (hazard map provider) stores hazard map 31 and detailed map 32 for autonomous driving. Note that although the exemplary embodiments are described assuming that hazard map 31 and detailed map 32 for autonomous driving are stored in identical storage apparatus 30 for the sake of simplicity, hazard map 31 and detailed map 32 for autonomous driving may be stored in separate storage apparatuses.

Hazard map 31 indicates, for each hazard type, the level of danger of a road in the case where a hazard has occurred. In one example, the level of danger of a road indicates the draining capacity of the road (for example, the volume of water that can be removed in a unit of time per unit area). Generally, as the draining capacity of a road is reduced, the level of danger of the road during rain increases. Furthermore, in one example, the level of danger of a road indicates whether or not any vehicles are prohibited to travel on the road.

In one example, hazard map 31 is updated at a predetermined timing. The predetermined timing is, for example, regularly or when a hazard occurs.

Detailed map 32 for autonomous driving is a road map required upon autonomous driving, and includes detailed information about roads. In one example, the detailed information is information about the shape of a road surface or the shape of an area around a road. Examples of the information about the shape includes a depth of a recess, a height of a projection, and an inclining degree.

In one example, detailed map 32 for autonomous driving is a map (ADAS map) used in an advance driver assistance system (ADAS). In this case, hazard handling system 1 may use, as detailed map 32 for autonomous driving, the ADAS map which autonomous driving control apparatus 2 uses.

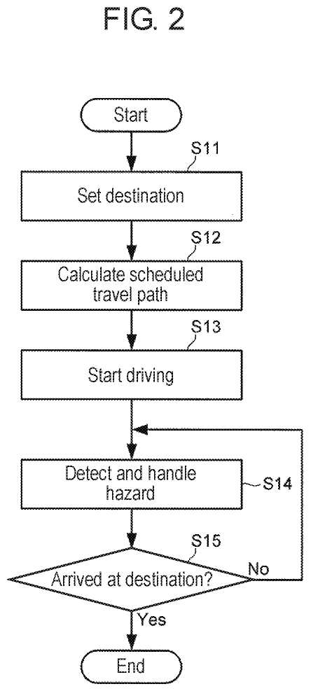

FIG. 2 is a flowchart illustrating the operational flow of hazard handling system 1 and autonomous driving control apparatus 2 according to the first exemplary embodiment. This process is achieved, for example, by the CPU in each of autonomous driving control apparatus 2, hazard detector 10, and hazard handler 20 by reading and executing the program stored in the ROM.

In Step S11, autonomous driving control apparatus 2 sets a destination for the vehicle. In one example, autonomous driving control apparatus 2 includes an interface (not illustrated in the drawings) for a user to input a destination for the vehicle, and autonomous driving control apparatus 2 sets the destination for the vehicle acquired via the interface.

In Step S12, autonomous driving control apparatus 2 calculates a scheduled travel path. In one example, using a road map included in detailed map 32 for autonomous driving, autonomous driving control apparatus 2 calculates a scheduled travel path having the shortest path length to the destination for the vehicle.

In Step S13, autonomous driving control apparatus 2 starts driving the vehicle. By controlling the speed, the steering angle, etc., of the vehicle, autonomous driving control apparatus 2 drives the vehicle.

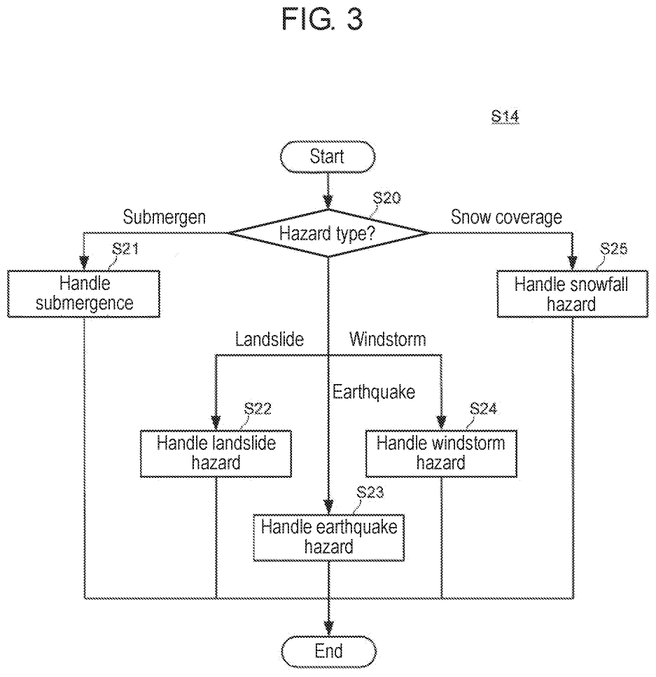

In Step S14, hazard handler 20 detects and handles a hazard. Details of the process of detecting and handling the hazard will be described later with reference to FIG. 3.

In Step S15, autonomous driving control apparatus 2 determines whether or not the vehicle has arrived at the destination. When the vehicle is determined as not having arrived at the destination (Step S15: NO), the processing returns to Step S14. Thus, the process of detecting and handling a hazard is performed continuously or intermittently until the vehicle arrives at the destination. When the vehicle is determined as having arrived at the destination (Step S15: YES), the flow ends.

FIG. 3 is a flowchart illustrating one example of the operational flow in Step S14 in the flowchart illustrated in FIG. 2.

In Step S20, hazard handler 20 discerns the hazard type indicated in the hazard information about the hazard which is detected to occur (a process in hazard type discriminator 21). When the hazard type is a submergence, the processing proceeds to Step S21. In one example, when the hazard type is a landslide, the processing proceeds to Step S22. In one example, when the hazard type is an earthquake, the processing proceeds to Step S23. In one example, when the hazard type is a windstorm, the processing proceeds to Step S24. In one example, when the hazard type is a snow coverage, the processing proceeds to Step S25.

When the processing proceeds to Step S21, hazard handler 20 handles the submergence hazard. When the processing proceeds to Step S22, hazard handler 20 handles the landslide hazard. When the processing proceeds to Step S23, hazard handler 20 handles the earthquake hazard. When the processing proceeds to Step S24, hazard handler 20 handles the windstorm hazard. When the processing proceeds to Step S25, hazard handler 20 handles the snow coverage hazard. Details of the processes in Step S21 to Step S25 will be described later with reference to FIG. 4 to FIG. 7.

Note that at least one of Step S21 to Step S25 may be performed. Furthermore, when the type of a hazard to be handled by hazard handler 20 is determined in advance, Step S20 can be skipped. Moreover, Step S21 to Step S25 may be sequentially performed in any order.

<Handling of Submergence Hazard>

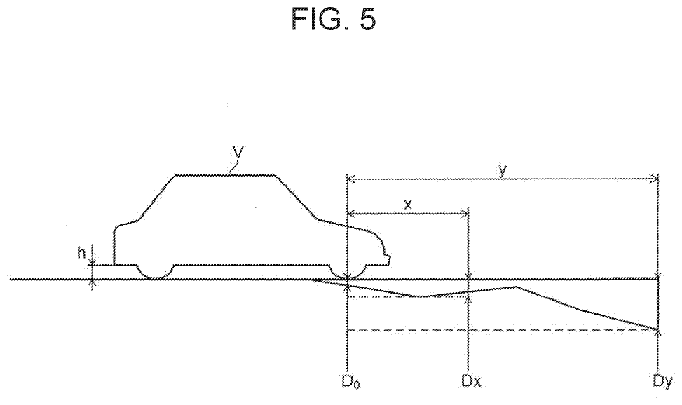

FIG. 4 is a flowchart illustrating one example of the operational flow in Step S21 in the flowchart illustrated in FIG. 3. FIG. 5 is a diagram for describing the maximum water level in the scheduled travel path.

In Step S31, hazard detector 10 determines whether or not the water depth at the current location acquired from in-vehicle sensor 12 is greater than the first threshold value (a process in scheduled travel path determiner 23). The first threshold value is an arbitrary value less than the maximum value of depth (limit depth) at which water does not enter vehicle V (refer to FIG. 5).

The maximum value of the water depth (maximum water depth) up to a point on the travel path that corresponds to path length x measured from a reference point (for example, the center point of a front tire-ground contact surface) of vehicle V is denoted by Dx. Similarly, the maximum water depth corresponding to path length y is denoted by Dy. The water depth at the current location is equal to maximum water depth Do corresponding to path length 0.

When the water depth at the current location is not greater than the first threshold value (Step S31: NO), the flow ends. Thus, there is no need to perform the following processes in Step S32 to Step S38 until vehicle V faces the risk of being flooded during travel; therefore, it is possible to reduce the calculation cost.

When the water depth at the current location is greater than the first threshold value (Step S31: YES), the processing proceeds to Step S32. In this case, as illustrated in FIG. 5, there is the possibility that the current scheduled travel path in which vehicle V is traveling may be flooded.

In Step S32, hazard handler 20 calculates maximum water depth Dx along the current scheduled travel path (a process in scheduled travel path determiner 23). In one example, scheduled travel path determiner 23 estimates the water depth on the basis of the amount of precipitation over the past predetermined time period indicated in the hazard information, the shape of a road surface shown in detailed map 32 for autonomous driving such as the depth of a recess or the height of a projection of the road surface and the inclining degree of the road surface, and the draining capability indicated in hazard map 31, at each point (location) on the current scheduled travel path, and acquires, as maximum water depth Dx, the maximum value of the water depth values estimated at the points.

In Step S33, hazard handler 20 determines whether or not limit depth h of vehicle V is greater than maximum water depth Dx, thereby determines whether it is safe or unsafe to travel through the current scheduled travel path (a process in scheduled travel path determiner 23). Upon determining that limit depth h of vehicle V is greater than maximum water depth Dx (Step S33: YES), hazard handler 20 warns autonomous driving control apparatus 20 of the risk of a flood or submergence of the road (a process in warning generator 25) (Step S38). On the other hand, when determining otherwise (Step S33: NO), the processing proceeds to Step S34.

In the case where the processing proceeds to Step S34, if vehicle V travels in the current scheduled travel path, vehicle V is likely to be submerged in water, meaning that it is unsafe for vehicle V to travel through the current scheduled travel path. Therefore, it is necessary to search for a scheduled travel path candidate different from the current scheduled travel path.

In view of this, in Step S34, hazard handler 20 searches for a scheduled travel path candidate (a process in scheduled travel path searcher 22). Next, in the same manner as in Step S32, hazard handler 20 calculates maximum water depth Dx of the retrieved scheduled travel path candidate (a process in scheduled travel path determiner 23). In one example, scheduled travel path searcher 22 searches for scheduled travel path candidates in ascending order from the shortest path length.

In Step S35, hazard handler 20 determines whether or not a scheduled travel path candidate in which limit depth h of vehicle V is greater than maximum water depth Dx is found as a scheduled travel path that is safe for vehicle V to travel (a process in scheduled travel path determiner 23). When the scheduled travel path candidate is found (Step S35: YES), the processing proceeds to Step S36. When the scheduled travel path candidate is not found (Step S35:

NO), the processing proceeds to Step S37.

In Step S36, hazard handler 20 instructs autonomous driving control apparatus 2 to change the current scheduled travel path to the scheduled travel path candidate that has been found (a process in scheduled travel path instructor 24). Upon receiving the instruction, autonomous driving control apparatus 2 drives vehicle V along a scheduled travel path in which limit depth h of vehicle V is greater than maximum water depth Dx. Thus, the risk of vehicle V being submerged in water can be reduced, and the risk of vehicle V being stalled before a flood through which vehicle V is not able to travel can also be reduced.

In the case where the processing proceeds to Step S37, vehicle V traveling through whichever scheduled travel path leading to the destination is likely to be submerged in water. For example, this is the case where the water depth at the destination is greater than limit depth h of vehicle V. Thus, in Step S37, hazard handler 20 warns autonomous driving control apparatus 2 of changing the destination (a process in warning generator 25). Upon receiving the warning, autonomous driving control apparatus 2 stops driving vehicle V along the scheduled travel path that has been set, and when necessary, drives vehicle V back to the point of departure. This allows vehicle V to avoid being submerged in water.

<Handling of Landslide Hazard>

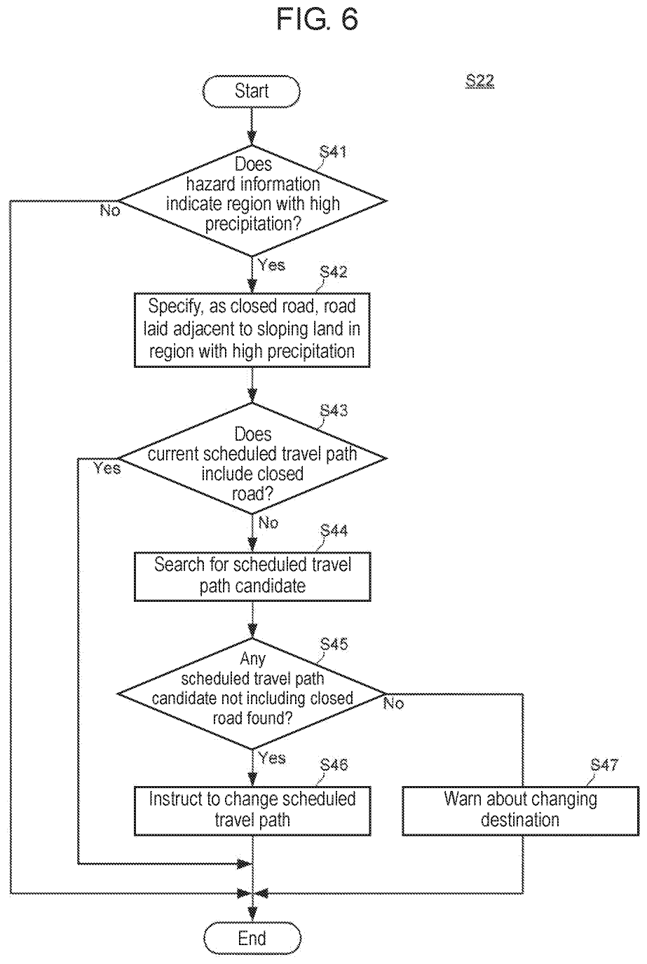

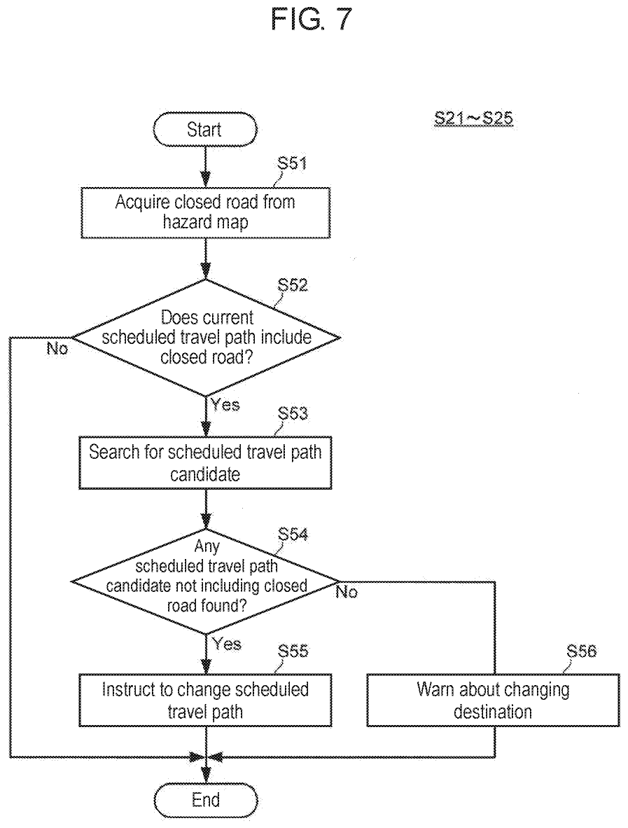

FIG. 6 is a flowchart illustrating one example of the operational flow in Step S22 in the flowchart illustrated in FIG. 3.

In Step S41, hazard handler 20 determines whether or not the hazard information indicates a region with much precipitation (a process in scheduled travel path determiner 23). In one example, on the basis of whether the amount of precipitation over the past predetermined time period indicated in the hazard information is greater than a second threshold value, hazard handler 20 determines whether or not the hazard information indicates a region with much precipitation. Here, the second threshold value is an arbitrary value determined in consideration of the possibility of occurrence of a landslide that leads to the need to avoid traveling.

When the hazard information is determined as not indicating a region with much precipitation (Step S41: NO), the possibility of occurrence of a landslide is considered relatively low, and the flow ends. When the hazard information is determined as indicating a region with much precipitation (Step S41: YES), the processing proceeds to Step S42.

In Step S42, hazard handler 20 specifies, as a closed (or travel-prohibited) road, a road laid adjacent to a sloping land in the region with much precipitation (_{a process} in scheduled travel path determiner 23). A landslide is considered relatively likely to occur in such a road laid adjacent to a sloping land in a region with much precipitation. Therefore, scheduled travel path determiner 23 specifies such a road as a closed road.

In one example, scheduled travel path determiner 23 specifies, as a closed road, a road that is located in the region with much precipitation indicated in the hazard information and is around an area with inclining degree greater than a third threshold value shown in detailed map 32 for autonomous driving. Here, the third threshold value is an arbitrary value determined in consideration of the possibility of occurrence of a landslide that leads to the need to avoid traveling.

In Step S43, hazard handler 20 determines whether or not the current scheduled travel path includes a closed road, thereby determines whether it is safe or unsafe to travel through the current scheduled travel path (a process in scheduled travel path determiner 23). When the current scheduled travel path is determined as not including a closed road (Step S43: YES), even if vehicle V travels in the current scheduled travel path, vehicle V is not likely to suffer damage. Therefore, because there is no need to change the scheduled travel path, the flow ends. On the other hand, when the current scheduled travel path is determined as including the closed road (Step S43: NO), the processing proceeds to Step S44.

In the case where the processing proceeds to Step S44, the current scheduled travel path includes a closed road. Therefore, it is necessary to search for another scheduled travel path candidate. In view of this, in Step S44, hazard handler 20 searches for a scheduled travel path candidate (a process in scheduled travel path searcher 22). Next, in the same manner as in Step S43, hazard handler 20 determines whether or not the scheduled travel path candidate includes a closed road, thereby determines whether it is safe or unsafe to travel through the scheduled travel path candidate (a process in scheduled travel path determiner 23). In one example, scheduled travel path searcher 22 searches for scheduled travel path candidates in ascending order from the shortest path length.

In Step S45, hazard handler 20 determines whether or not a scheduled travel path candidate that does not include a closed road is found as a scheduled travel path that is safe for vehicle V to travel (a process in scheduled travel path determiner 23). When the scheduled travel path candidate is found (Step S45: YES), the processing proceeds to Step S46. When the scheduled travel path candidate is not found (Step S45: NO), the processing proceeds to Step S47.

In Step S46, hazard handler 20 instructs autonomous driving control apparatus 2 to change the current scheduled travel path to the scheduled travel path candidate that has been found (a process in scheduled travel path instructor 24), and the flow ends. Upon receiving the instruction, autonomous driving control apparatus 2 drives vehicle V along a scheduled travel path that does not include a closed road. Thus, the risk of vehicle V suffering damage can be reduced, and the risk of vehicle V being stalled before a landslide through which vehicle V is not able to travel can also be reduced.

In the case where the processing proceeds to Step S47, vehicle V traveling through whichever scheduled travel path leading to the destination is likely to suffer damage. For example, this is the case when the destination itself is located along a closed road. Thus, in Step S47, hazard handler 20 warns autonomous driving control apparatus 2 of changing the destination (a process in warning generator 25), and the flow ends. Upon receiving the warning, autonomous driving control apparatus 2 stops driving vehicle V along the scheduled travel path that has been set, and when necessary, drives vehicle V back to the point of departure. This allows vehicle V to avoid suffering damage.

<Handling of General Hazard>

FIG. 7 is a flowchart illustrating one example of the operational flow in Step S21 to Step S25 in the flowchart illustrated in FIG. 3. For example, for the submergence hazard, the flowchart illustrated in FIG. 4 may be used, or the flowchart illustrated in FIG. 7 may be used. Furthermore, for example, for the landslide hazard, the flowchart illustrated in FIG. 6 may be used, or the flowchart illustrated in FIG. 7 may be used.

In Step S51, hazard handler 20 acquires closed roads for vehicle V from hazard map 31 (a process in scheduled travel path determiner 23). Each of the closed roads is, for example, a road susceptible to submergence damage, a road susceptible to landslide or rockfall damage, a road susceptible to tsunami damage caused by an earthquake, a road susceptible to windstorm damage, or a road susceptible to snow coverage damage.

In Step S52, hazard handler 20 determines whether or not the current scheduled travel path includes a closed road, thereby determines whether it is safe or unsafe to travel through the current scheduled travel path (a process in scheduled travel path determiner 23). In a case where the current scheduled travel path is determined as not including a closed road (Step S52: NO), even if vehicle V travels in the current scheduled travel path, vehicle V is not likely to suffer damage. Therefore, because there is no need to change the scheduled travel path, the flow ends. On the other hand, when the current scheduled travel path is determined as including a closed road (Step S52: YES), the processing proceeds to Step S53.

In the case where the processing proceeds to Step S53, the current scheduled travel path includes a closed road. Therefore, it is necessary to search for another scheduled travel path candidate. In view of this, in Step S53, hazard handler 20 searches for a scheduled travel path candidate (a process in scheduled travel path searcher 22). Next, in the same manner as in Step S52, hazard handler 20 determines whether or not the scheduled travel path candidate includes a closed road, thereby determines whether it is safe or unsafe to travel through the scheduled travel path candidate (a process in scheduled travel path determiner 23). In one example, scheduled travel path searcher 22 searches for scheduled travel path candidates in ascending order from the shortest path length.

In Step S54, hazard handler 20 determines whether or not a scheduled travel path candidate that does not include a closed road is found as a scheduled travel path that is safe for vehicle V to travel (a process in scheduled travel path determiner 23). In a case where the scheduled travel path candidate is found

(Step S54: YES), the processing proceeds to Step S55. In a case where the scheduled travel path candidate is not found (Step S54: NO), the processing proceeds to Step S56.

In Step S55, hazard handler 20 instructs autonomous driving control apparatus 2 to change the current scheduled travel path to the scheduled travel path candidate that has been found (a process in scheduled travel path instructor 24), and the flow ends. Upon receiving the instruction, autonomous driving control apparatus 2 drives vehicle V along a scheduled travel path that does not include a closed road. Thus, the risk of vehicle V suffering damage can be reduced, and the risk of vehicle V being stalled before a closed road can also be reduced.

In the case where the processing proceeds to Step S56, vehicle V traveling through whichever scheduled travel path leading to the destination is likely to suffer damage. For example, this is the case when the destination itself is located along the closed road. Thus, in Step S56, hazard handler 20 warns autonomous driving control apparatus 2 of changing the destination (a process in warning generator 25), and the flow ends. Upon receiving the warning, autonomous driving control apparatus 2 stops driving vehicle V along the scheduled travel path that has been set, and when necessary, drives vehicle V back to the point of departure. This allows vehicle V to avoid suffering damage.

As described above, hazard handling system 1 according to the first exemplary embodiment includes a hazard map provider (storage apparatus 30), hazard detector 10, and scheduled travel path determiner 23. The hazard map provider (storage apparatus 30) provides hazard map 31 indicating the level of danger on a road where a hazard occurs. Hazard detector 10 detects the occurrence of a hazard. When the occurrence of a hazard is detected, scheduled travel path determiner 23 determines, on the basis of the level of danger, whether it is safe or unsafe for vehicle V to travel through a first scheduled travel path, and upon determining that the traveling through the first scheduled travel path is unsafe, scheduled travel path determiner 23 determines, on the basis of the level of danger, a second scheduled travel path which is safe for vehicle V to travel.

Hazard handling system 1 the first exemplary embodiment determines a scheduled travel path that is safe for vehicle V to travel, if necessary, at the time of the occurrence of a hazard, and thus vehicle V can travel through a scheduled travel path that is safe for vehicle V to travel.

Hazard handling system 1 according to the first exemplary embodiment determines the scheduled travel path on the basis of the hazard information acquired by communicator 11, the measurement data acquired by in-vehicle sensor 12, hazard map 31, detailed map 32 for autonomous driving, and the current location of vehicle V. Therefore, for example, it is possible to determine whether or not to include, in the scheduled travel path, even a road on which no one has passed immediately after the occurrence of a hazard and from which no information has been brought from other vehicles, pedestrians, etc.

Hazard handling system 1 according to the first exemplary embodiment can collectively cope with many types of hazards such as a submergence, a landslide, an earthquake, a windstorm, and a snow coverage which may damage a vehicle or hinder the travel of a vehicle. Thus, autonomous driving control apparatus 2 is capable of collectively and uniformly coping with many types of hazards regardless of the types of hazards.

### Second Exemplary Embodiment

A second exemplary embodiment is a variation of the first exemplary embodiment. In the second exemplary embodiment, elements that are the same as or corresponding to the elements in the first exemplary embodiment are assigned the same reference numerals as in the first exemplary embodiment, and duplicate description thereof will be omitted. Moreover, details not mentioned herein are substantially the same as those in the first exemplary embodiment unless any inconsistencies arise.

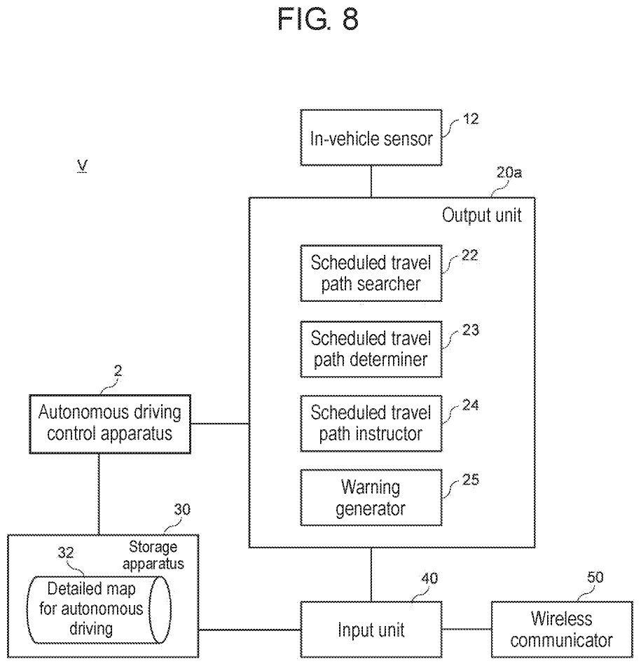

FIG. 8 is a configuration diagram of vehicle V according to the second exemplary embodiment. Vehicle V includes autonomous driving control apparatus 2, in-vehicle sensor 12, output unit 20a, storage apparatus 30, input unit 40, and wireless communicator 50. Under the control of autonomous driving control apparatus 2, vehicle V autonomously travels in a path (scheduled travel path) in which vehicle V is scheduled to travel, according to a destination and so on which has been set. Specifically, vehicle V is an autonomous vehicle which requires no driving operation by a driver.

Note that although the following description assumes that vehicle V is an autonomous vehicle, functions in the following description other than autonomous driving control apparatus 2 are applicable to vehicles other than autonomous vehicles. In other words, regarding the functions in the following description that are provided without using autonomous driving control apparatus 2, vehicle V does not necessarily need to be an autonomous vehicle.

In-vehicle sensor 12 detects a water surface at a location in a traveling direction. For example, in-vehicle sensor 12 is a fathometer which measures the water depth from the bottom to the top (water surface) of a submergence part in the current location of the vehicle using ultrasonic waves, etc., and generates measurement data indicating the depth.

Storage apparatus 30 stores detailed map 32 for autonomous driving. As in the case of the first exemplary embodiment, detailed map 32 for autonomous driving is a road map required upon autonomous driving, and including detailed information about roads. Detailed map 32 for autonomous driving according to the second exemplary embodiment includes elevation information of a road as the detailed information. The elevation information of a road is, for example, information of the elevation above sea level of the road. As in the case of the first exemplary embodiment, an ADAS map which autonomous driving control apparatus 2 uses may be used as detailed map 32 for autonomous driving.

Wireless communicator 50 performs wireless communication. For example, wireless communicator 50 supports the mobile communication system, the wireless metropolitan area network (WMAN), and the like, and performs wireless communication using these systems.

Input unit 40 receives the elevation information of the scheduled travel path from detailed map 32 for autonomous driving stored in storage apparatus 30.

Instead of receiving the elevation information of the scheduled travel path from detailed map 32 for autonomous driving, input unit 40 may receive the elevation information of the scheduled travel path from an external server or the like via wireless communicator 50.

Vehicle V according to the second exemplary embodiment includes output unit 20a instead of hazard handler 20 according to the first exemplary embodiment. Output unit 20a includes scheduled travel path searcher 22, scheduled travel path determiner 23, scheduled travel path instructor 24, and warning generator 25. Details of scheduled travel path searcher 22, scheduled travel path determiner 23, scheduled travel path instructor 24, and warning generator 25 that are not mentioned herein are substantially the same as those in the first exemplary embodiment unless any inconsistencies arise.

Scheduled travel path searcher 22 of output unit 20a searches for a new scheduled travel path candidate.

Scheduled travel path determiner 23 of output unit 20a acquires maximum water depth Dx in the current scheduled travel path. Specifically, scheduled travel path determiner 23 estimates maximum water depth Dx in the scheduled travel path in the traveling direction on the basis of the elevation information received by input unit 40 and the water surface (for example, the water depth) at a location in the traveling direction detected by in-vehicle sensor 12, during autonomous driving along the scheduled travel path.

Furthermore, when estimated maximum water depth Dx in the scheduled travel path is equal to or greater than a predetermined value, scheduled travel path determiner 23 determines a new scheduled travel path (a second path) that is safe for vehicle V to travel from among new scheduled travel path candidates retrieved by scheduled travel path searcher 22. Specifically, when a water depth at every location in the traveling direction along the new scheduled travel path is not estimated to be equal to or greater than the predetermined value on the basis of the elevation information of the new scheduled travel path received by input unit 40 and the water surface detected by in-vehicle sensor 12, scheduled travel path determiner 23 determines the new scheduled travel path (the second path).

When maximum water depth Dx in the scheduled travel path estimated by scheduled travel path determiner 23 is equal to or greater than the predetermined value, scheduled travel path instructor 24 of output unit 20a instructs autonomous driving control apparatus 2 to start the travel through the second path different from the first path. The first path is a scheduled travel path in which vehicle V is traveling at a point in time before the instruction to start the travel through the second path. The second path is a new scheduled travel path determined by scheduled travel path determiner 23 as a scheduled travel path that is safer for vehicle V to travel.

When maximum water depth Dx in the scheduled travel path estimated by scheduled travel path determiner 23 is equal to or greater than the predetermined value, warning generator 25 of output unit 20a provides a warning. For example, when a water depth at a location in a traveling direction along the scheduled travel path is estimated to be equal to or greater than the predetermined value on the basis of the elevation information of the scheduled travel path received by input unit 40 and the water surface detected by in-vehicle sensor 12 while vehicle V autonomously travels along the scheduled travel path, warning generator 25 provides a warning about the possibility of a submergence.

Furthermore, for example, when a water depth at a location in a traveling direction along the scheduled travel path is estimated to be equal to or greater than a predetermined value on the basis of the elevation information of the scheduled travel path received by input unit 40 and the water surface detected by in-vehicle sensor 12 while vehicle V autonomously travels along the scheduled travel path, warning generator 25 provides a warning about changing the destination.

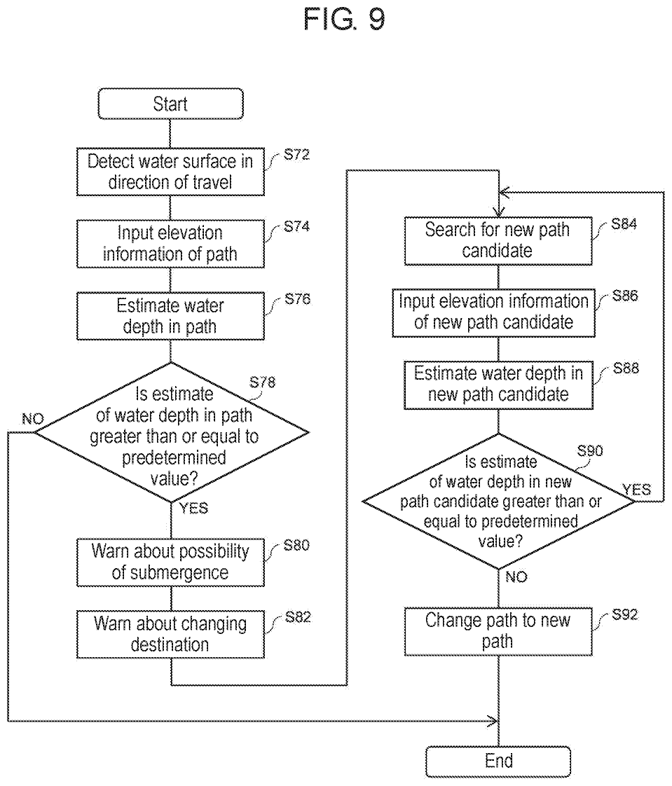

FIG. 9 is a flowchart illustrating an operational flow of vehicle V according to the second exemplary embodiment. This process is achieved, for example, by the CPU in each of autonomous driving control apparatus 2 and output unit 20a which reads and executes the program stored in the ROM. Autonomous driving control apparatus 2 and output unit 20a of vehicle V perform the process illustrated in FIG. 9, for example, regularly, while vehicle V autonomously travels along the scheduled travel path; thus, it is possible to ensure the safe travel of vehicle V.

In Step S72, in-vehicle sensor 12 detects a water surface at a location in the traveling direction along the scheduled travel path. For example, in-vehicle sensor 12 measures the water depth from the bottom to the top (water surface) of a submergence part in the current location of the vehicle using ultrasonic waves, etc., and generates measurement data indicating the depth.

Next, in Step S74, input unit 40 receives the elevation information of the scheduled travel path. Specifically, input unit 40 receives the elevation information of the scheduled travel path from detailed map 32 for autonomous driving in storage apparatus 30. Instead of receiving the elevation information of the scheduled travel path from detailed map 32 for autonomous driving, input unit 40 may receive the elevation information of the scheduled travel path from an external server or the like via wireless communicator 50.

Next, in Step S76, scheduled travel path determiner 23 of output unit 20a estimates water depths at locations in the scheduled travel path on the basis of the elevation information of the scheduled travel path and the water surface (for example, the water depth) in the scheduled travel path detected by in-vehicle sensor 12. Scheduled travel path determiner 23 may calculate maximum water depth Dx in the current scheduled travel path. Specifically, scheduled travel path determiner 23 estimates maximum water depth Dx in the scheduled travel path along the traveling direction on the basis of the elevation information received by input unit 40 and the water surface (for example, the water depth) in the traveling direction detected by in-vehicle sensor 12 while vehicle V autonomously travels along the scheduled travel path.

Next, in Step S78, scheduled travel path determiner 23 of output unit 20a determines whether or not any of the estimated values of the water depths in the scheduled travel path is equal to or greater than the predetermined value. Scheduled travel path determiner 23 preferably determines whether or not the estimated value of maximum water depth Dx in the scheduled travel path is equal to or greater than the predetermined value. When the estimated value of the water depth in the scheduled travel path is less than the predetermined value (for example, when the estimated value of maximum water depth Dx is less than the predetermined value) (Step S78: NO), the processing ends. When the estimated value of the water depth in the scheduled travel path is equal to or greater than the predetermined value (for example, when the estimated value of maximum water depth Dx is equal to or greater than the predetermined value) (Step S78: YES), the processing proceeds to Step S80.

In Step S80, warning generator 25 of output unit 20a provides a warning about the possibility of a submergence. Next, in Step S82, warning generator 25 of output unit 20a provides a warning about changing the destination.

Next, in Step S84, scheduled travel path searcher 22 of output unit 20a searches for a new scheduled travel path candidate. For example, scheduled travel path searcher 22 searches for scheduled travel path candidates in ascending order from the shortest path length.

Next, in Step S86, input unit 40 receives the elevation information of the new scheduled travel path candidate retrieved by scheduled travel path searcher 22. The method for inputting the elevation information is substantially the same as in Step S74.

Next, in Step S88, scheduled travel path determiner 23 of output unit 20a estimates water depths at locations in the new scheduled travel path candidate retrieved by scheduled travel path searcher 22. The method for estimating the water depths is substantially the same as in Step S76.

Next, in Step S90, scheduled travel path determiner 23 of output unit 20a determines whether or not the estimated values of the water depths in the new scheduled travel path candidate retrieved by scheduled travel path searcher 22 is equal to or greater than the predetermined value. The method for the determination is substantially the same as in Step S78.

When any of the estimated values of the water depths at the locations in the new scheduled travel path candidate is equal to or greater than the predetermined value (for example, when the estimated value of maximum water depth Dx is equal to or greater than the predetermined value) (Step S90: YES), the processing proceeds to Step S84. In this case, in Step S84, scheduled travel path searcher 22 of output unit 20a searches for the next new scheduled travel path candidate. For example, scheduled travel path searcher 22 searches for a new scheduled travel path candidate having the second shortest path length after the path length of the last new scheduled travel path candidate that has been retrieved.

When any of the estimated value of the water depths at the locations in the new scheduled travel path candidate is less than the predetermined value (for example, when the estimated value of maximum water depth Dx is less than the predetermined value) (Step S90: NO), the processing proceeds to Step S92.

In Step S92, scheduled travel path determiner 23 of output unit 20a changes the scheduled travel path to the new scheduled travel path. Specifically, the new scheduled travel path candidate retrieved by scheduled travel path searcher 22 of output unit 20a in Step S84 is determined as a new scheduled travel path (second path), and the scheduled travel path is changed from the (existing) scheduled travel path (first path) to the new scheduled travel path (second path),. Thereafter, scheduled travel path instructor 24 of output unit 20a instructs autonomous driving control apparatus 2 to start travelling through the new scheduled travel path (second path). Under the control of autonomous driving control apparatus 2, vehicle V then starts autonomously traveling along the new scheduled travel path (second path). Subsequently, the processing ends.

Note that the process in Step S80, the process in Step S82, and the process in the Step S84 to S92 do not need to be performed in the order described with reference to FIG. 9; for example, these three processes may be performed in a different order or may be performed in parallel. Furthermore, it is not always necessary to perform all of the process in Step S80, the process in Step S82, and the process in the Step S84 to S92, and one or two of these three processes may be performed.

Furthermore, the process in Step S72 and the process in Step S74 do not need to be performed in the order described with reference to FIG. 9; for example, these processes may be performed in a different order or may be performed in parallel.

As described above, the vehicle according to the second exemplary embodiment is capable of autonomously traveling along a path and includes: an input unit configured to receive elevation information of the path; a sensor configured to detect a water surface in a traveling direction; and an output unit.

In one example, when a water depth at a location in a traveling direction along a predetermined path (scheduled travel path) is estimated to be equal to or greater than a predetermined value on the basis of the elevation information of the predetermined path received by input unit 40 and the water surface detected by the sensor (in-vehicle sensor 12) while vehicle V autonomously travels along the predetermined path, output unit 20a provides a warning about the possibility of a submergence. With this, it is possible to improve the safety of vehicle V while traveling.

In another example, when a water depth at a location in a traveling direction along a predetermined path (scheduled travel path) is estimated to be equal to or greater than a predetermined value on the basis of the elevation information of the predetermined path received by input unit 40 and the water surface detected by the sensor (in-vehicle sensor 12) while vehicle V autonomously travels along the predetermined path, output unit 20a provides a warning about changing the destination. With this, it is possible to improve the safety of vehicle V while traveling.

In yet another example, when a water depth at a location in a traveling direction along the first path ((existing) scheduled travel path) is estimated to be equal to or greater than a predetermined value on the basis of the elevation information of the first path received by input unit 40 and the water surface detected by the sensor (in-vehicle sensor 12) while vehicle V autonomously travels along the first path, vehicle V starts autonomously traveling along the second path (new scheduled travel path) different from the first path. With this, it is possible to improve the safety of vehicle V while traveling.

In yet another example, vehicle V starts autonomously traveling along the second path when the following two conditions are satisfied at the same time. Condition 1: A water depth at a location in a traveling direction along the first path ((existing) scheduled travel path) is estimated to be equal to or greater than a predetermined value on the basis of the elevation information of the first path received by input unit 40 and the water surface detected by the sensor (in-vehicle sensor 12) while vehicle V autonomously travels along the first path. Condition 2: Each of water depths at locations in the traveling direction along the second path (new scheduled travel path) is estimated to less than the predetermined value on the basis of the elevation information of the second path input to input unit 40 and the water surface detected by the sensor (in-vehicle sensor 12). With this, it is possible to improve the safety of vehicle V while traveling.

As described above, the vehicle according to the second exemplary embodiment is capable of improving the safety of the vehicle while traveling.

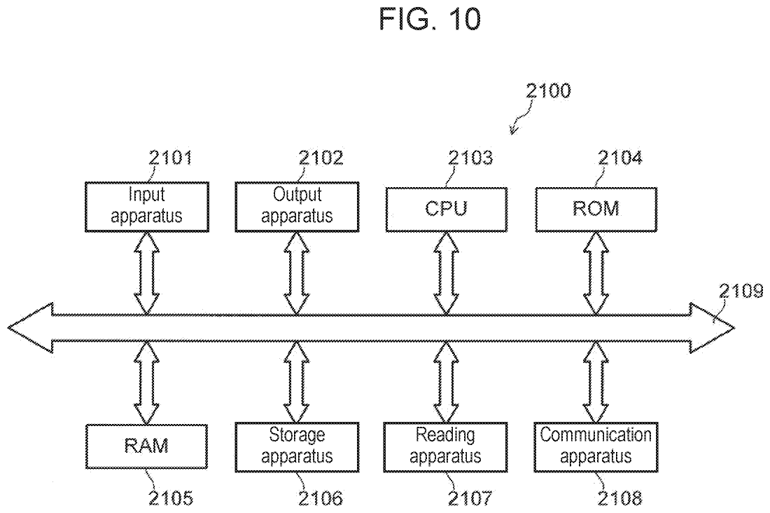

FIG. 10 is a diagram illustrating one example of the hardware configuration of a computer. The function of each of the abovementioned elements according to the first and second exemplary embodiments can be achieved using a program which computer 2100 executes.

As illustrated in FIG. 10, computer 2100 includes: input apparatus 2101 such as an input button and a touch pad; output apparatus 2102 such as a display and a loudspeaker; central processing unit (CPU) 2103; read-only memory (ROM) 2104; and random-access memory (RAM) 2105. Furthermore, computer 2100 includes: storage apparatus 2106 such as a hard disk device and a solid-state drive (SSD); reading apparatus 2107 which reads information from a recording medium such as a digital versatile disk read-only memory (DVD-ROM) and a universal serial bus (USB) memory; and communication apparatus 2108 which performs communication via a network. The abovementioned elements are connected via bus 2109.

Reading apparatus 2107 reads a program for implementing the function of each of the above elements from a recording medium having the program recorded thereon, and causes storage apparatus 2106 to store the program. Alternatively, communication apparatus 2108 performs communication with a server apparatus connected to the network, and causes storage apparatus 2106 to store a program downloaded from the server apparatus. The program is for implementing the function of each of the above elements.

Subsequently, CPU 2103 copies, to RAM 2105, the program stored in storage apparatus 2106, and sequentially reads and executes commands included in the program from RAM 2105, thereby implements the function of each of the above elements. Furthermore, when executing of the program, RAM 2105 or storage apparatus 2106 stores the information acquired in various processes described in the exemplary embodiments, and the information is used as appropriate.

Furthermore, as another example, the function of each of the abovementioned elements in the first and second exemplary embodiments can be implemented as a physical circuit such as a dedicated integrated circuit (IC) and a large-scale integration (LSI).

In the first exemplary embodiment, storage apparatus 30 implements the function of the hazard map provider. Specifically, scheduled travel path determiner 23 acquires hazard map 31 from storage apparatus 30. Instead of this, another exemplary embodiment is also conceivable in which scheduled travel path determiner 23 acquires hazard map 31 from communicator 11 included in hazard detector 10. For example, it is also conceivable that hazard information acquired by communicator 11 includes hazard map 31. In this case, communicator 11 implements the function of the hazard map provider.

In the first exemplary embodiment, hazard handler 20 acquires a closed road for vehicle V from hazard map 31 in Step S51. Instead of this, another exemplary embodiment is also conceivable in which scheduled travel path determiner 23 of hazard handler 20 acquires a closed road for vehicle V on the basis of the hazard information and detailed map 32 for autonomous driving.

In the first and second exemplary embodiments, scheduled travel path determiner 23 determines whether it is safe or unsafe to travel through a scheduled travel path that has been set in autonomous driving control apparatus 2. Next, when traveling through the scheduled travel path is determined as being unsafe, scheduled travel path determiner 23 determines another scheduled travel path that is safe to travel, and scheduled travel path instructor 24 instructs autonomous driving control apparatus 2 to change the scheduled travel path. Instead of this, another exemplary embodiment is also conceivable in which scheduled travel path determiner 23 determines whether it is safe or unsafe to travel through a scheduled travel path that has been set in a car navigation system (not illustrated in the drawings), and scheduled travel path instructor 24 instructs the car navigation system to change the scheduled travel path to another scheduled travel path that is safe. In this case, the car navigation system is connected instead of autonomous driving control apparatus 2. Thus, the present disclosure is applicable to a non-autonomous vehicle as well.

The present disclosure is favorably used as a vehicle such as a vehicle capable of autonomously traveling along a path.

What is claimed is:

1. A vehicle capable of autonomously traveling through a path, the vehicle comprising:
an input unit configured to receive elevation information of the path;
a sensor configured to detect a water surface in a traveling direction of the vehicle; and
an output unit configured to provide a warning about a possibility of a submergence when a water depth at a location in a traveling direction along a predetermined path is estimated to be equal to or greater than a predetermined value base on elevation information of the predetermined path received by the input unit and a water surface in the predetermined path detected by the sensor while the vehicle autonomously travels along the predetermined path.

2. The vehicle according to claim 1,
wherein, when the water depth at the location is estimated to be equal to or greater than the predetermined value while the vehicle autonomously travels along the predetermined path, the output unit is configured to further provide a warning about changing a destination of the vehicle.

3. The vehicle according to claim 1,
wherein the predetermined path is defined as a first path, and
the vehicle is configured to start autonomously traveling through a second path different from the first path when the water depth at the location in the traveling direction along the first path is estimated to be equal to or greater than the predetermined value based on the elevation information of the first path received by the input unit and the water surface in the first path detected by the sensor while the vehicle autonomously travels along the first path.

4. The vehicle according to claim 3,
wherein the vehicle is configured to start autonomously traveling through the second path different when the water depth at the location in the traveling direction along the first path is estimated to be equal to or greater than the predetermined value based on the elevation information of the first path received by the input unit and the water surface in the first path detected by the sensor while the vehicle autonomously travels along the first path, and each of water depths at locations in a traveling direction along the second path is not estimated to be equal to or greater than the predetermined value based on elevation information of the second path received by the input unit and a water surface in the second path detected by the sensor.
